(19) United States
(12) Patent Application Publication
(10) Pub. No.: US 2011/0248995 A1
(43) Pub. Date: Oct. 13, 2011

(54) SYSTEM AND METHODS FOR CREATING INTERACTIVE VIRTUAL CONTENT BASED ON MACHINE ANALYSIS OF FREEFORM PHYSICAL MARKUP

(75) Inventors: James VAUGHAN, Sunnyvale, CA (US); Donald Kimber, Foster City, CA (US); Eleanor Rieffel, Mountain View, CA (US); Kathleen Tuite, Seattle, WA (US); Jun Shingu, Kanagawa (JP); Sagar Gattepally, Fremont, CA (US)

(73) Assignee: FUJI XEROX CO., LTD., Tokyo (JP)

(21) Appl. No.: 12/757,849

(22) Filed: Apr. 9, 2010

(51) Int. Cl. G06T 17/40

(52) U.S. Cl. 345/420

(57) ABSTRACT

Systems and methods are described for creating virtual models, primarily through actions taken in actual 3D physical space. For many applications, such systems are more natural to users and may provide a greater sense of reality than can be achieved by editing a virtual model at a computer display, which requires the use of manipulations of a 2D display to effect 3D changes. Actions are taken (markup is drawn or laid out, etc.) in a physical workspace. Such physical workspaces may in fact be identical to the space being modeled, small physical scale models of the space, or even a whiteboard or set of papers or objects which get mapped onto the space being modeled.

### BACKGROUND

1. Field of the Invention

This invention relates in general to systems for providing interactive virtual content and, more particularly, to providing interactive virtual content based on freeform markup.

2. Description of the Related Art

Building a virtual model is a laborious and time-consuming process, requiring making measurements in the physical space and possibly editing the computer generated model. For example, there exist systems that support the task of model creation by allowing users to create and manipulate models by simply marking up an object or scene with preprinted markers. Images or video of the scene are then collected and processed. The system is able to determine the camera pose for each image, the position of all markup, and then interpret the markup to create models. An example of the use of such a system to create a room model is shown in FIG. 1. In fieldwork with such systems, the requirement for an appropriate set of preprinted decorated markers was often found to be inconvenient, and that the necessary documentation of the fieldwork was difficult, and often incomplete. Therefore, there is a need for systems and methods that allow for the creation of virtual models in which freeform markup can be used to replace or augment preprinted markers.

### SUMMARY

The inventive methodology is directed to methods and systems that substantially obviate one or more of the above and other problems associated with present modeling systems.

In one aspect of an embodiment of the present invention there is a system for creating virtual models based on physical freeform markup, the systems including a display; a physical workspace; a camera aimed at the physical workspace, the camera receiving imagery from said physical workspace; and a processor processing from the imagery either a live video stream, previously recorded video, or a collection of images from the camera. The processor further executes instructions which include identifying and processing physical freeform markup on the physical workspace; rendering a virtual model based on the physical freeform markup; and displaying the virtual model on the display.

Aspects of embodiments of the present invention further include systems for creating interactive virtual content based on physical freeform markup, the system including a display; a physical workspace; a camera aimed at the physical workspace, the camera receiving imagery from said physical workspace; and a processor processing live video from the camera. The processor executes instructions including identifying and processing, from the imagery, physical freeform markup on the physical space; deriving a path from the physical freeform markup. A command based on the physical freeform markup may also be derived.

Additional aspects related to embodiments of the invention will be set forth in part in the description which follows, and in part will be apparent from the description, or may be learned by practice of the invention. Aspects of embodiments of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an example of a model of a room created by marking up with printed markers.

FIG. 2: illustrates an example floor plan with markers, with an augmented reality (AR) model shown, hand drawn strokes on a floor plan, and extruded walls in the context of the AR model.

FIG. 3: illustrates an example whiteboard rig and tools for stroke markup of models. Strokes can be drawn on the whiteboard, or on the sides of the dry-erase cube. Wires can be used to define 3D shapes.

FIG. 4: illustrates an example schematic overview of a system for providing interactive virtual content according to an embodiment of the invention.

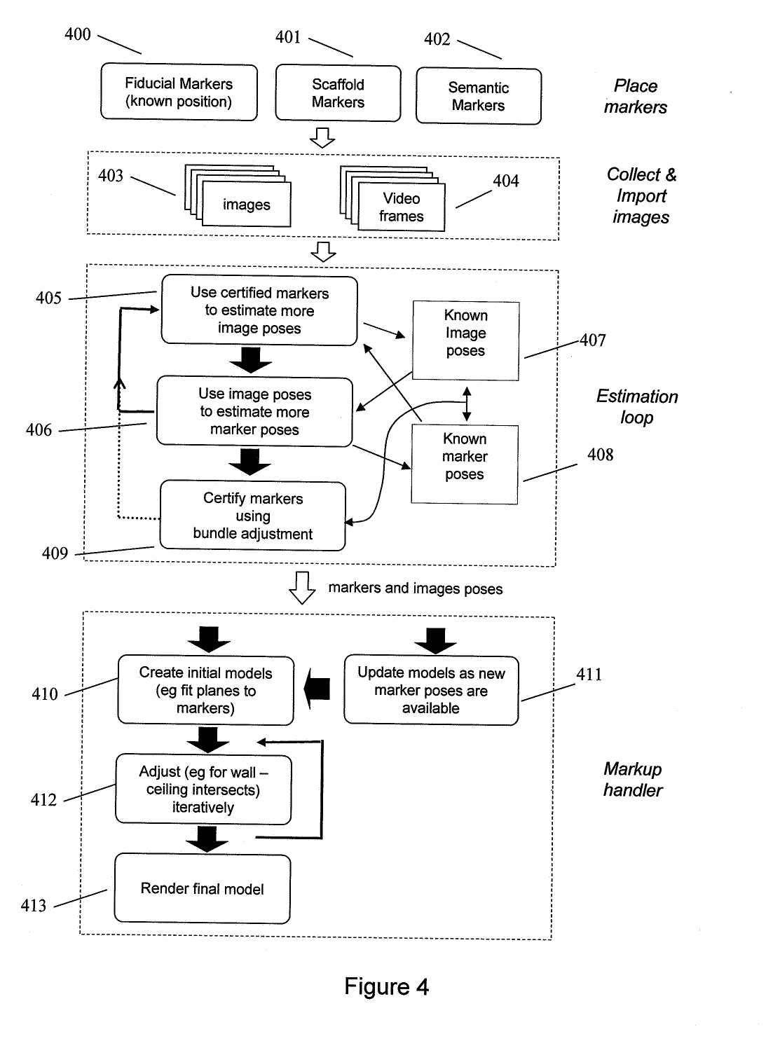

FIG. 5: illustrates steps involved in stroke extraction.

FIG. 6: illustrates contour contraction and Freeman direction codes.

FIG. 7 illustrates a lookup table key for computing collapsed contours.

FIG. 8 illustrates examples of intrinsic stroke markings, such as simple smooth strokes, cross ticks, and arrowheads.

FIG. 9 illustrates examples of pre-decorated and labeled marker, and freeform decorated marker.

FIG. 10 illustrates an example of a fully freeform markup for defining a cylinder.

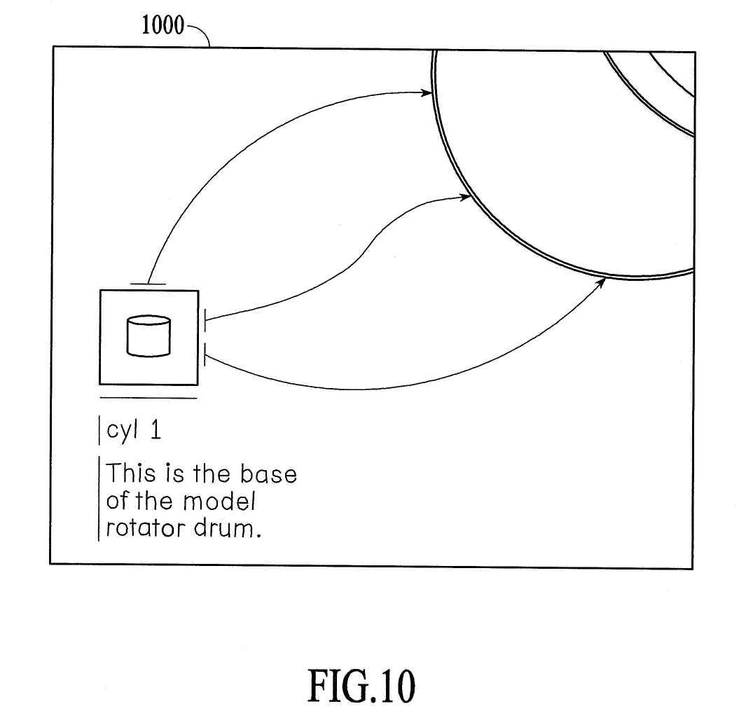

FIG. 11: illustrates example stroke and markup processing utilized by the system for providing interactive virtual content.

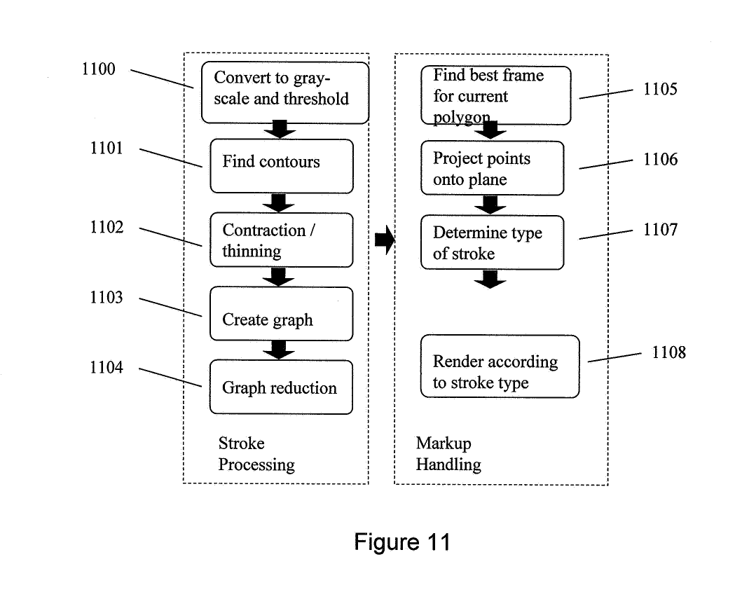

FIG. 12: illustrates an example functional diagram in which the system may be implemented.

FIG. 13: illustrates an example flow chart of one of the embodiments of the invention.

FIG. 14 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

The techniques described here allow users to add the necessary decoration for defining metadata, and for providing documentary annotation, by simply writing on or near the markers. Also, because the set of markers is discrete, it can be cumbersome, or even impossible to define some geometric shapes such as arbitrary curves. The present systems and techniques allow users to simply draw those shapes. The strokes of these drawings may be created by pen on flat or curved surfaces, or even created using wires, strings or ropes to define ‘3D strokes’. For purposes of explanation, a path is a continuous set of 3D points parameterizable by a single real parameter. A stroke is a set of one or more connected paths. A planar stroke (2D stroke) is a stroke containing only points lying on a single plane.

Embodiments of the present invention encompass systems and methods for using freeform physical markup of physical spaces, scale models, and objects to create and manipulate interactive virtual models. The markup may involve handwritten pen strokes, or even placed wires or strings which are interpreted as elements of a markup language describing model properties. To create models or define interactive properties such as animation paths, a user marks up a physical workspace, and collects images or video which are interpreted by the system. The system determines the pose of the images and determines the three dimensional placement of the markup, and can thereby determine the model properties. For example, given a model of a room, a window may be added to the model by placing a sheet of paper where the window would be placed, and drawing the outline of the window. On a factory floor, a colored rope can be placed to show the path where a conveyor should be placed. The method can be applied either in scale model space, such as over a floor-plan or architectural mockup, or in the actual space being modeled.

### Example Application Areas

Certain embodiments of the present invention allow users to create virtual models, primarily through actions taken in actual 3D physical space. For many applications, this approach is more natural to users and may provide a greater sense of reality than can be achieved by editing a virtual model at a computer display, which requires the use of manipulations of a 2D display to effect 3D changes. In the utilization of certain embodiments of the present invention, actions are taken, (markup is drawn or laid out, etc.) in a physical workspace. That physical workspace may in fact be identical to the space being modeled, it may be a small physical scale model of the space, or may simply be a whiteboard or set of papers or objects, which get mapped onto the space being modeled. To further aid the user, the virtual model can be overlaid onto the live camera video stream and displayed on the computer display, so that the user can view how the model changes with added markup or movement.

### Marking-Up a Physical Space

One set of applications involves marking-up a physical space, capturing images and using those images to produce a model of that space. Embodiments of the present invention can be used for any such application area that current available systems are used for, but with the advantage of less reliance on markers, and greater flexibility in describing complex geometry. In addition to creating models of physical objects or spaces, the embodiments of the present invention allow markup by strokes drawn on paper, or placed wires, to describe hypothetical additional geometry that is not part of the physical space but may be of interest. These applications include laying out cubicle walls in an open-plan office using rope, placing a curved archway into a wall, or defining the location of furniture. Laying out the markup is significantly less effort to the user than building a full scale version of the geometry or creating a virtual model at a computer.

The methods described here can be used both to describe spaces and objects as they are, and also to describe hypothetical extensions or additions to those spaces. For this reason, many aspects of the present invention are complementary to and supported by augmented reality (AR) viewing, which allows a user to see a physical space or scale model augmented with elements described by the markup.

### Marking-Up a Scale Model

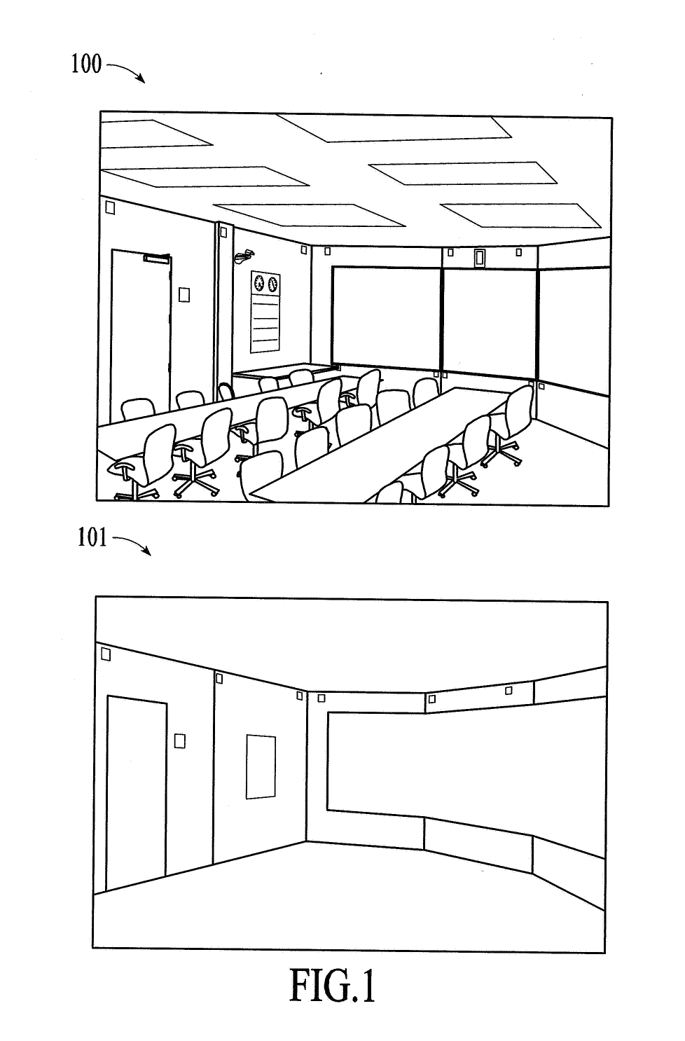

FIG. 1 illustrates an example of a virtual model created by markers. By marking up a room with markers (for example, square markers placed on the top of walls to indicate the wall contours 100), the system can create a virtual model based off of the detected markers 101.

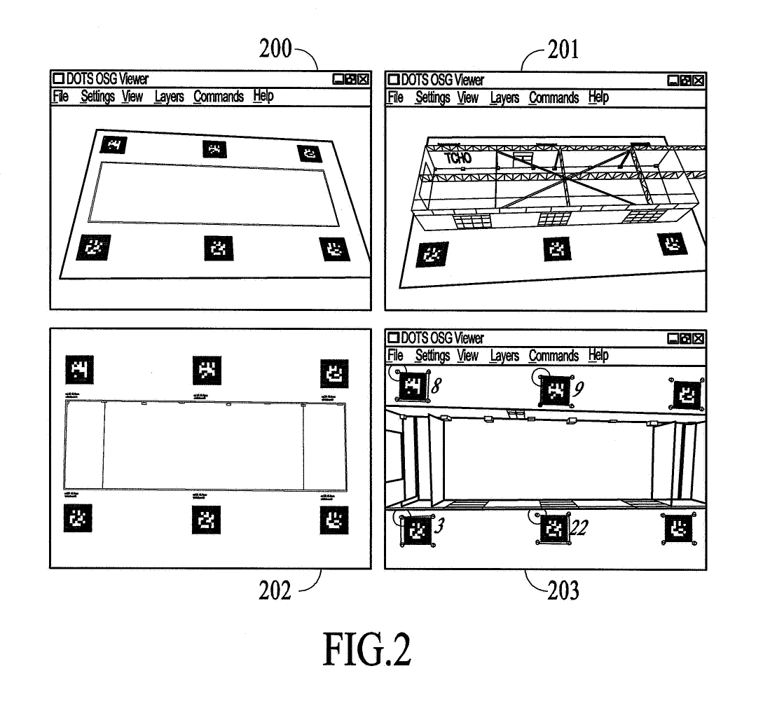

Another set of applications relates to the use of strokes to markup a scale model, such as an architectural diagram or foam board mockup of a building. The first example presented uses hand-drawn strokes to add geometry to a model with the use of an Augmented Reality (AR) viewer as shown in FIG. 2. The upper left example 200 shows a building floor plan with markers. The markers have a dual purpose: they describe the location where an AR viewer should place a model of the building, and they define a polygonal region in which the strokes are interpreted. The upper right example 201 shows the same diagram, but with a virtual model of the building superimposed. In the lower left example 202, the user has drawn two strokes to indicate where walls should be placed. The system detects these strokes and they are projected onto the plane defined by the markers, and from this, walls had been created by extrusion of the stroke vertically. The walls are shown in the context of the AR model in the lower right example 203.

Strokes can also be drawn in scale models to add geometry in the form of replicated unit cells along a path. Near the strokes, a preprinted or hand drawn marker could be added to indicate the type of unit cells being replicated. This method can be used for example to show the path of track to be added to a model railroad. Similarly, drawn strokes, or even wires or string could be used to show paths of a conveyor line, or of pipes, to be added to a factory model. If those paths are non-planar, wires can still be used for these strokes.

### Marking a Workspace for Manipulation of Virtual Models

In the previous examples, the physical workspace being marked up was identical to the actual space being modeled, or was a scale model of the space. Although this is a very natural setting, there are still some limitations. For example, when drawing on a factory floor plan to show a proposed layout of the factory, the scale appropriate for drawing walls to a large area may be different from the natural scale for showing the layout of cubicles. In any typical 3D computer modeling tool, this is handled by zooming the model and panning around. Although it is possible to pan and zoom when using a fixed model, the mapping between the physical and virtual models will change.

To address this limitation, the mapping of the physical workspace to the space being modeled can be dynamically adjusted by the user. For example, a model of the building can be mapped onto a whiteboard so that initially the building is aligned with a floorplan centered in the whiteboard. In fact, a convenient way to do this is to initially place the floorplan onto the whiteboard, thus ‘loading’ the model onto the whiteboard. Using an AR viewer, the user can see the outer walls of the factory over the whiteboard, and draw strokes indicating the placement of inside walls, as described above. After markup processing, the added walls will also be visible in the viewer. Then however, the user may erase all drawn strokes from the whiteboard (and remove the printed floorplan if it was still present), and scale and pan the mapping of the building model onto the whiteboard in order to zoom in to a particular area of the factory. Then, additional strokes are drawn to indicate placement of cubicle boundaries.

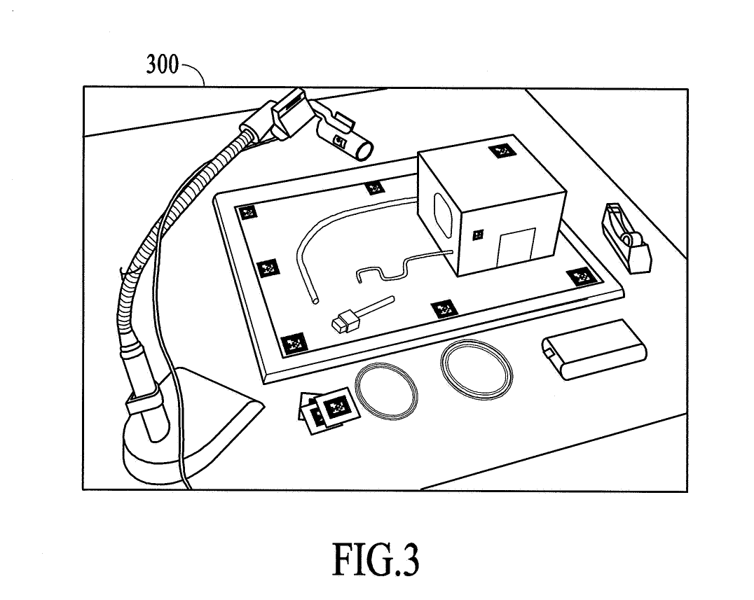

This technique is not restricted to a two dimensional work surface. For example a dry erase “whitebox” can be used, and any orthogonal corner of a space being modeled may be mapped to a corner of the whitebox, with an appropriate scale. (Appropriate work space tools could be made for mapping onto the inside or outside of orthogonal surfaces this way.) Such a set of workspace tools 300 is shown in FIG. 3. This allows users to draw markup with a drawing implement on one surface, say representing a floor, and markup on the orthogonal surface representing a wall. Markings on the wall can be used for example to indicate the height of cubicles formed by extruding marks drawn on the floor. Or wires may be added to show paths of pipes.

Other Uses of Stroke Based Markup in Modeling

As well as describing visible elements of geometry in models, the techniques described here could also be used for other aspects of modeling. These include:

Animations. Drawn strokes or placed wires can be used to show the paths where inserted models will be moved during animations. The speed for the animations can be taken as uniform, or tick marks can be drawn on the stroke to indicate speed variations (e.g. motion can be proportional to tick mark spacing.) Objects can also be animated along the strokes or placed wires to indicated movement.

Commands. Strokes may be used as commands to the markup engine, such as to show groupings of different elements, by circling those elements. During interactive sessions with an AR viewer, strokes may be drawn to indicate erasures. Strokes can also be useful as commands to indicate remapping of the physical workspace to the model view, such as to indicate which area to zoom into. For example, on a whiteboard, strokes can be drawn that show where two points in the current view map to two points on the floorplan. After the mapping is transformed, those strokes are erased.

Motion constraints. These constraints could take the form of a path along which an object could move, or the limit of movement for which an object, such as a door, or drawer could have. Strokes can also be used to show joint relationships between two bodies, such as where a pin joint should be added.

Sensors and alarms. Some modeling systems such as VRML have a notion of sensors, that can be used to trigger actions when the viewpoint in a browser (typically this is the position of an avatar) enters a region. Strokes or wires in a space could be used to define these regions. Video surveillance systems (for example the DOTS system) allow the user to define ‘activity hotspots’ which are regions in which motion or other activity is detected. Activity hotspots can be defined by annotating an image from the system to provide a mask. An application of this invention is to use rope or other such material to define an activity hotspot by laying it out in the field of view of one of the cameras and have the system interpret its path.

System Overview

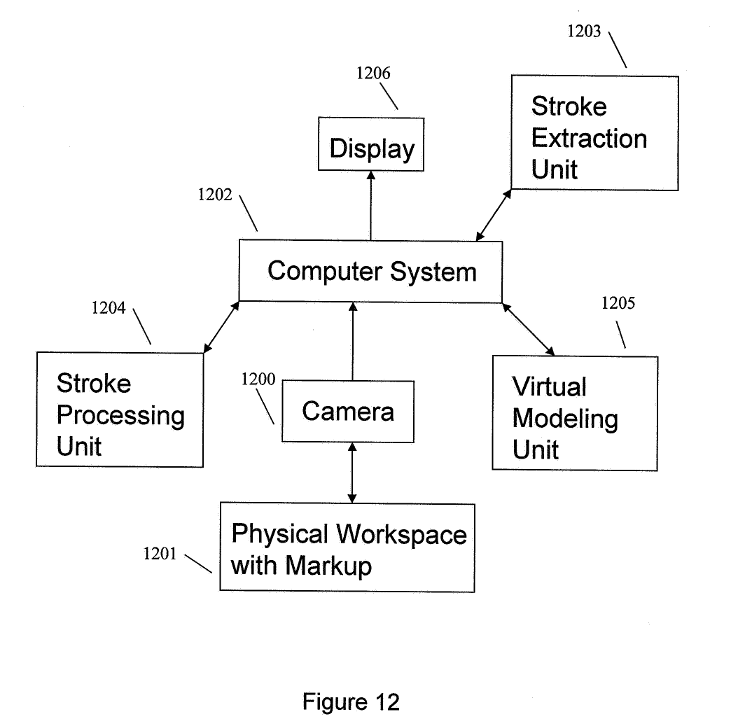

FIG. 12 illustrates an example schematic overview of a system for providing interactive virtual content according to an embodiment of the invention. Markers such as the fiducal markers 400, scaffold markers 401 and semantic markers 402 are placed for detection. During the collection of images, the system embodiment can utilize a camera to capture images 403 and/or video frames 404 to detect the placed markers. The system embodiment detects the placed markers in images and determines the relative pose of each marker 405 to the camera, or in other words, the position and orientation of the marker relative to the camera. Mathematically, this corresponds to a transform which maps a point expressed in the marker coordinate system to the same point expressed in the camera coordinate system. This is a rigid body transform with 6 degrees of freedom, corresponding to an arbitrary translation and rotation. It is invertible, and the inverse transform gives the position of the camera relative to the marker. If the pose of a marker in the world is known 407, then for any image in which that marker is clearly visible, the position of the camera when the image was collected can also be determined 408. Furthermore, if the pose of some marker is initially unknown, but the marker is detected in some image for which the camera pose can be determined, the pose of that marker can then also be determined 406. By repeating calculations of this form, and given a sufficient set of images, it is possible to estimate the pose of every marker and the camera pose for every image 409. When estimates for the poses of a set of images and markers have been determined, the estimates can be improved by a global optimization called Bundle Adjustment.

Once the pose of every marker has been determined, the system applies the semantic meaning of the markers to produce the virtual model 410, and the virtual model can be updated as new marker poses are made available 411. A ‘markup-handler’ sub-system generates portions of the model, for example walls, by fitting planes to the markers associated with those portions, and interpreting the interaction between the portions of the model. For example, the intersections of walls, ceilings and floors are used to terminate the associated planes 412. As the adjustments are made, the final virtual model can thereby be rendered 413.

Stroke Detection and Processing

The stroke extraction component of the system finds markings in images that correspond to hand drawn strokes, or to visible wires, strings, ropes, etc., that are being used to control markup. For this application, a convenient output representation of the strokes is as grouped polylines or parameterized paths along the skeletons of the strokes. A number of approaches could be taken to finding the strokes.

One approach is to take images as input and produce vector form output such as SVG (scalable vector graphics) files. Such approaches do a good job of accurately representing curves from the images as polylines or splines. However, the representation of a drawn stroke is a sequence of splines and polylines along the contour of the stroke. It is necessary to post process those contours to determine the skeleton. One implementation of skeletonization that can be used for this is provided by the package Computation Geometry Algorithm Library (CGAL) [CGAL].

A problem with using such an approach as a first step of processing, followed by skeletonization using CGAL, is speed. This kind of processing can take many seconds on a high resolution image, or even on mere 920×760 pixel images. Ideally in the “video mode” of the inventive system, the user can see the results of the stroke detection subsystem as the system is collecting images, so the user knows when a view is adequate and the detected strokes match their intention.

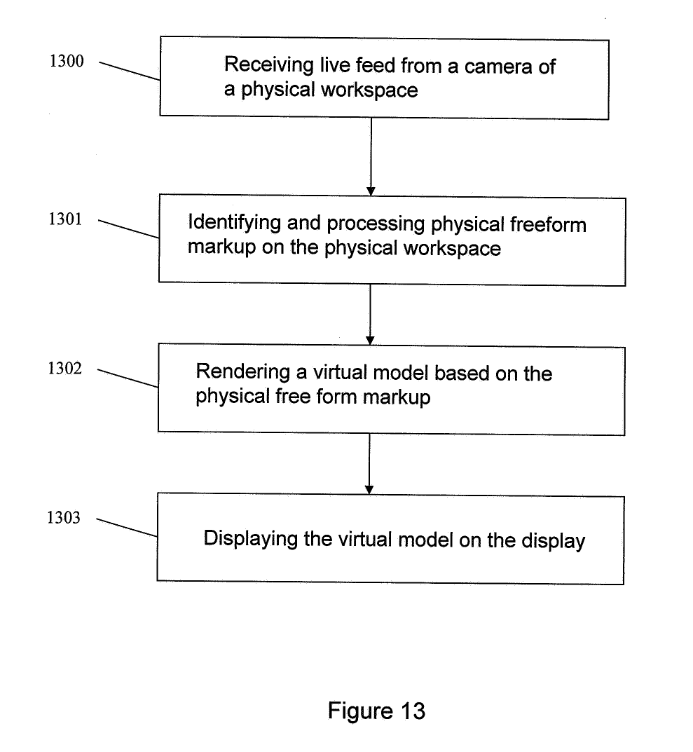

FIG. 13 illustrates steps involved in stroke extraction. To support this kind of more interactive use of the system, the inventive system utilizes a form of stroke extraction that can process several strokes per second. The basic steps involved providing interactive virtual content involved are outlined in accordance to an embodiment of the invention.

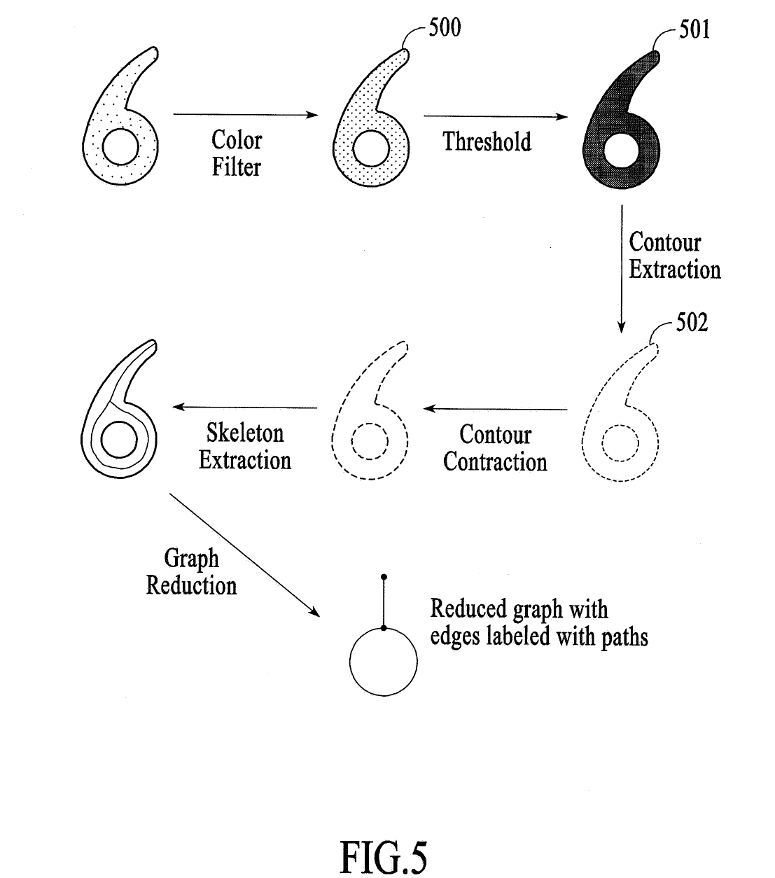

FIG. 5: This implementation first converts images from color to grayscale 500, then thresholds the gray images to binary black and white images 501. The conversion from color to grayscale can be color filter based, to emphasize strokes of a given color. Given the black and white images, contours are found 502, which correspond to the perimeter of connected components in the images. The contours may be nested, in the case of connected components that are not simply connected, with some contours along the outside perimeter of those strokes, and other contours along the ‘holes’ of the strokes.

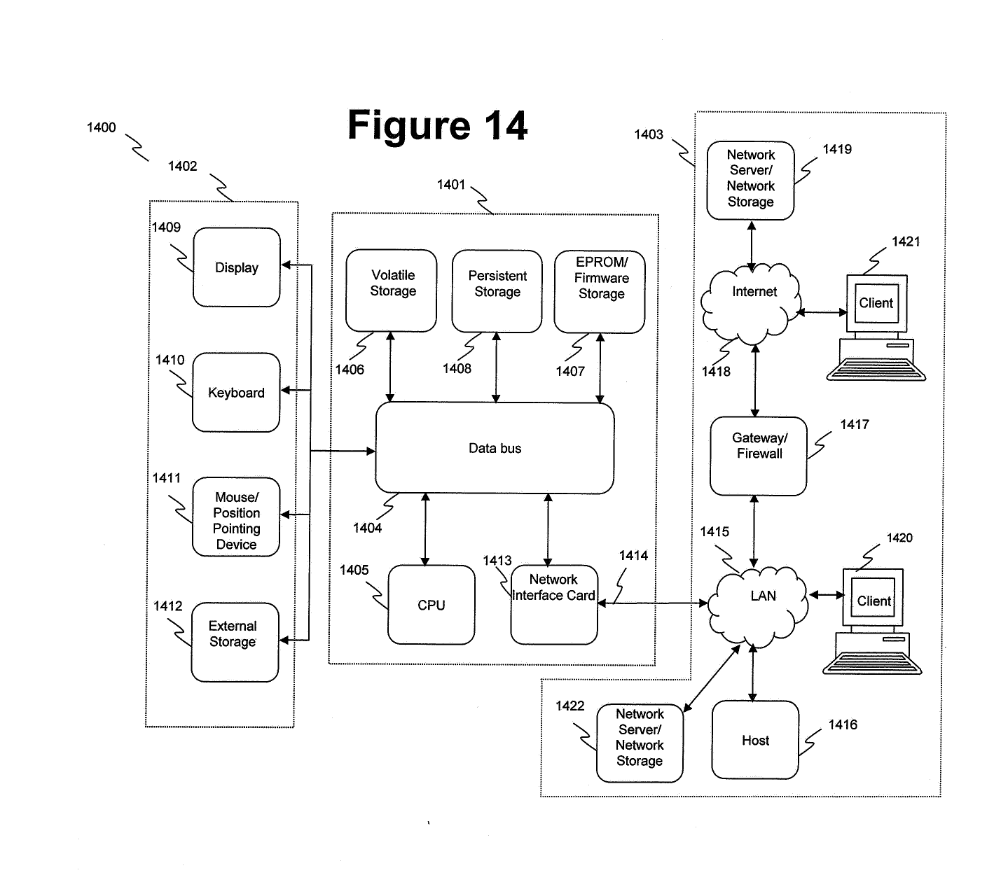

FIG. 14: illustrates the contour contraction step of FIG. 5 and the Freeman direction codes. Contours can be represented as chains of pixels. Contour contraction ‘pushes’ contour pixels to adjacent pixels to the left. The figure shows a portion of a contour 600 on top, and the result of contracting it on the bottom. This can be computed quickly using Freeman coding of contours and lookup tables. For each pixel in a contour, the position of the next pixel in the contour is in one of 8 possible directions 601. Note that for a well formed contour, for each successive pair of pixels, there are 8×7=56 possible pairs of values, since for any pixel, the incoming and outgoing edges do not coincide.

The collections of contours still need to be processed for skeletonization. This can be implemented by an iterative process in which contours are progressively ‘contracted’ until they can not be contracted anymore without passing through themselves or other contours. This corresponds to ‘thinning’ the connected component regions delineated by those contours. To implement this efficiently, the contours can be represented as directed graphs, with nodes corresponding to pixels, and with edges corresponding to adjacent pixels along the contours. The direction from each pixel to the next adjacent pixel along the path can be ‘Freeman-chain’ encoded as one of 8 possible directions 601, which are shown in

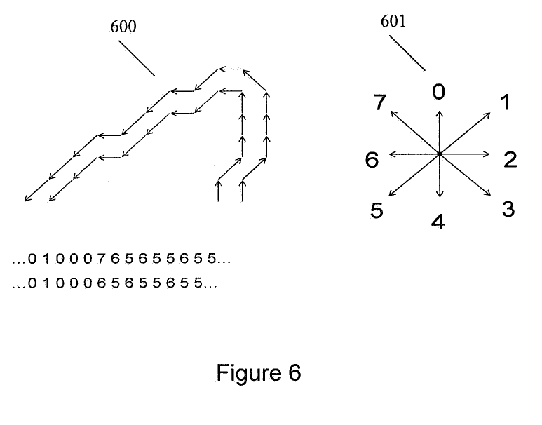

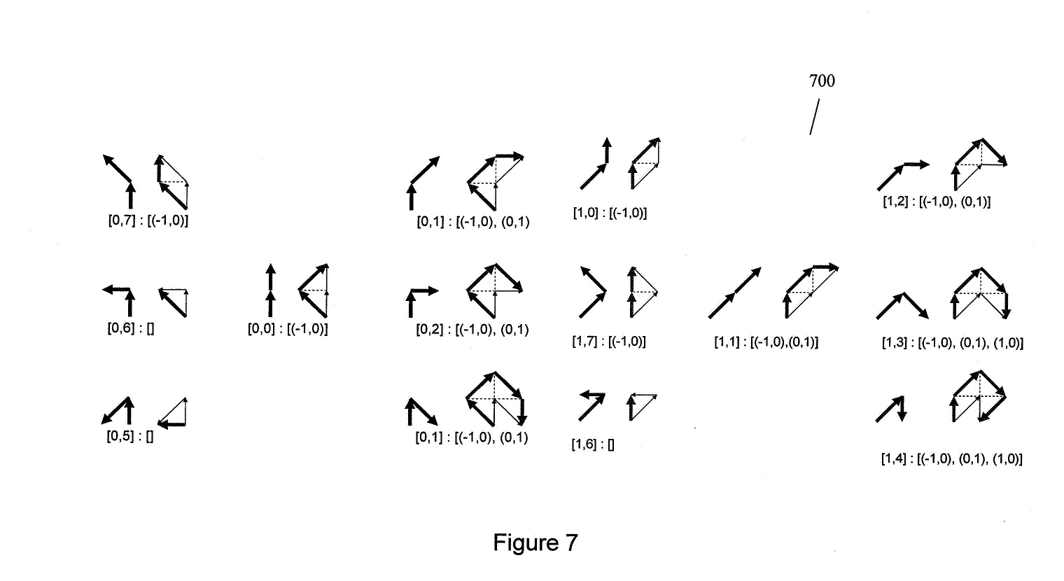

FIG. 6. The contour contraction can be performed by moving along a contour, and ‘pushing it in’ to the interior. That is, each node on the contour is replaced by nearby nodes interior to the contour. If the external perimeter contours of a connected component are traversed counterclockwise, and internal contours (i.e. holes) are traversed clockwise, then ‘pushing in’ the contour corresponds to ‘pushing it to the left’. This process can be performed quickly, using a lookup table that shows for each node, based on the directional codes of the edge leading into the node and the edge leading out, what nodes it should be replaced with to contract the contour, as shown in FIG. 7.

FIG. 15 illustrates a Lookup table key 700 for computing collapsed contours. Each node n (pixel position) of a contour has a Freeman code index for the edge entering the node n, and the edge leaving the node. Those indices can be used to look up the set of nodes on the collapsed contour that n should be replaced with to ‘push in’ the contour at n. The coordinates of those nodes are given relative to the position of n. Performing this operation effectively replaces the edges of the original contour with the edges of the contracted contour. Note that depending on the directions involved, a node may be replaced by 0, 1, 2, or 3 nodes. Only 14 of the 56 possible needed lookup values are shown. The other 42 are equivalent to these, through rotational symmetry. When nodes are moved to the same positions as other nodes, those nodes are ‘frozen’ and no longer adjusted. The procedure is continued until no more nodes can be adjusted. At that point, each node of the contour graph has two incoming edges and two outgoing edges, oriented in different directions. It can then be converted to an undirected graph, defining the skeleton of the region. The paths through this graph are the skeleton of the regions, as indicated in FIG. 5.

The next step in the stroke extraction processing after the contour contraction is graph reduction on the skeleton graph, as shown in FIG. 5. The initial skeleton graph has a node for each pixel on the skeleton. A portion of the path along the skeleton has many edges of degree two. Suppose the graph has successive nodes n1, n2, n3, with an edge (n1,n2) and an edge (n2,n3). Then, a new graph, homomorphic to the first, can be produced by removing n2, and replacing edges (n1,n2) and (n2,n3) with edge (n1,n3). To preserve the information about the actual path in the image, the edges of this graph are augmented with the actual pixel path, which is the concatenation of the pixel path from n1 to n2 and the pixel path from n2 to n3. Reduction of the graph in this manner preserves topological properties of the graph, and can lead to a much simpler equivalent graph. The output of the connected component processing portion of stroke detection is a reduced graph for each connected component, with the edges of the graph corresponding to entire sub-paths of the component. A single clean curved stroke is thus represented as a graph having just two nodes, and a single edge connecting them. That edge is labeled with data corresponding to the entire path along the skeleton, containing every pixel. This sequence can then be approximated by a polyline with many fewer segments, which lies within a given distance threshold of the path.

A variety of methods for skeletonization could also be used. For example, one good approach is a “thinning and boundary propagation” approach as mentioned above. One quality of this algorithm compared with approaches such as morphology is that it can be selectively applied to contours, which may be preselected for viability as possible candidates for strokes. A stroke with a limited thickness w should have the property that the total area of its connected region should be not much greater than w*L/2 where L is the length of the perimeter contour.

An optional final level of stroke extraction is grouping. There are two types of grouping that may be useful. One is within connected components, and the other is across multiple connected components. Within a connected component, each edge of the skeleton graph represents a segment of the stroke. However, it is typically useful to further group the segments within a component. For example, given a long stroke with short crossing tick-marks, it is most convenient to group all of the edges along the length of the stroke as a single path. This can be done by finding the longest path through the graph, and determining if all other strokes are short. Additionally strokes may be grouped across connected components, on the basis of proximity and stroke direction. This would allow a dashed or dotted line to be treated as one stroke.

Treatment of Strokes Across Images and Time

The stroke processing described above is applied to each image. For some applications, strokes can be meaningfully used even with a single image. But for many applications, it is necessary to group strokes across images. Consider a stroke drawn in the world, and its projection onto a first image. That same stroke will have a different appearance in a second image taken from a different position. In fact, if each image displays multiple strokes, it may be unclear which stroke in one image corresponds to which in the second.

There are two ways the system can deal with this issue and establish stroke correspondences. If the actual shape of a stroke in the world is known, even only approximately, then that shape can be projected onto any image with a known pose, and compared with nearby strokes detected in that image. If the Hausdorff distance between the projected stroke and the nearest detected stroke in the image is small, and no other detected stroke is also nearby in Hausdorff distance, then the detected stroke is taken as corresponding to the stroke in world space, and therefore to any other image strokes that correspond to that world stroke.

Another way to establish stroke correspondences, when even an approximate estimate of the shape of the stroke in the world is unknown, is to compare nearby images. The inventive system supports both still image and video input. When the camera is moved, successive frames from the video correspond to very similar camera poses. So again, Hausdorff distance can be used to compare a detected stroke in one image with detected strokes in the other image. Once stroke correspondences are established in this way, the method described in the next section can be used to estimate the path of the actual stroke in the world. Another temporal aspect of strokes across time is video that captures the drawing or erasing of strokes.

For many purposes it suffices to consider strokes that are entirely visible within images. In some cases however, images may show only portions of strokes, and in fact a stroke may not be entirely visible in any one image. However, if a sufficient set of images with poses is collected showing different portions of the stroke, the whole stroke can be reconstructed by tying together the estimates of its different portions seen in different images.

3D Processing of Strokes

The strokes from an image are paths in the image parameterizable by a single real value. For most markup purposes, it is necessary to determine the actual 3-dimensional path of the stroke in the world. The simplest case of this is when the path is drawn on a planar surface, of known orientation. This is the case for example of strokes in a sketch drawn on a flat surface such as a whiteboard or floor plan, where markers or some other means may be used to know the position of the surface relative to the camera. It is then a straightforward process to project the points along the stroke from the image to the plane on which the stroke is known to be drawn or placed. Each point of the stroke in the image corresponds to a ray emanating from the camera center of projection through the image plane. The intersection of that plane with the plane on which the stroke is drawn gives the corresponding 3D point of the stroke.

In cases where the strokes are non-planar, or the orientation of the plane on which they lie is unknown, the 3-d paths of the strokes can be determined using epipolar geometry, in a manner similar to triangulation. First consider a world point, as seen in two images taken with known pose. For the point as seen in one image, there is an entire ray of points in world space that project to that same point in the image. Similarly that same point as seen in the other image, corresponds to another ray. The intersection of those rays (or the nearest point of intersection when some noise is present and the rays do not intersect) is the estimate of the point in the world. However this triangulation requires knowing the correspondence of points seen in the two images. What if an entire path is visible in both images? Although a point may be selected along the path in one image, the system must determine which point along the path in the other image that it corresponds to. This can be done by drawing the epipolar line of the first point, in the second image, and seeing where it intersects the path. That is, the ray of points in the world that all correspond to the point as seen in the first image would show up as a line—the so called epipolar line—in the second image. That line must intersect the path as seen in the second image. The point of intersection gives the corresponding point. Triangulation can then be used to determine the world point. In this manner, a sampling of points along the path as seen in the first image can be matched with the points along the path as seen in the second image, and each pair triangulated to determine the actual shape of the path in 3-dimensional world space. Note that this method breaks down in one case. Suppose that for some point on the path as seen in image one, the epipolar line intersects the second path at multiple points. What is worse, some portion of the curve as seen in the second image may be coincident with the epipolar line. That means that there are a whole set of points on the path in image two that could correspond to the point. This ambiguity can be avoided by using images from other positions.

An alternative method for capturing the 3D path of wires may be appropriate for another embodiment of this invention. Their method requires a single image of the wire, and is based on the assumption that the wire has a consistent circular cross section of constant width as described in Caglioti, “A manipulable Vision-Based 3D Input Device for Space Curves, Springer, 2008. Another related technology called shape tape, can provide the 3D shape of a flat strip.

Stroke Classification and Labeling

Once strokes have been extracted from images and represented as graphs, the final step of low level processing before markup interpretation is classification and labeling. This includes determining whether a stroke should even be used by the system, and if so, how. Many strokes in the images will simply be part of the ‘background noise’ of the workspace and should be ignored. The categories of stroke are:

Noise: These strokes arise from pre-existing lines or texture in the workspace, or as artifacts of camera motion as the focus and auto gain adjusts.

Labels: These are written labels from a fixed low vocabulary alphabet or symbol set. They can be used to indicate the type or group of a marker, such as “wall 1”. They can be decoded using existing handwriting recognition technologies.

Annotations. These are any writing or drawing that the user wants to document their markup work. They are not further interpreted but are stored by the system and are available the interface.

Geometric Modifiers: These are markings near a marker that indicate a a region for use for color or texture sampling.

Curve Definitions: These are drawn paths that indicate a geometric curve, to help in such tasks as defining paths for extrusions.

Command Symbols: These strokes indicate commands to the system, such as ‘insert an extrusion’, ‘delete all model components in this region’, ‘group these components’, or ‘begin processing’. Some strokes may be both a command and a curve definition.

Several methods can be used to help reject unwanted noise strokes, and to classify meaningful strokes. These include:

Proximate markers: The markers near strokes may help define or modify the meaning of those strokes. They may indicate how it is to be used, e.g. defining a base for an extrusion, or whether to ‘clean up’ the stroke and replace it by polylines or splines.

Color. A distinctive color can be used to distinguish user drawn strokes from noise. The color can also be used to classify the type of stroke.

Semantic Regions: An active region can be defined relative to one or more markers. For example, markers may have “label regions” and “comment annotation regions”. Also, a set of markers may be used to define a work area where all strokes are interpreted as curve definitions, say to be used for defining extrusions or animation paths.

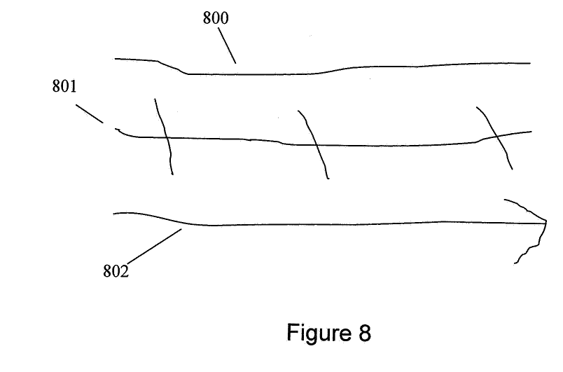

Intrinsic stroke properties. The actual properties of the strokes themselves can also be used to distinguish among stroke types. For example, as shown in FIG. 8, strokes with cross ticks 801, can indicate replication of unit cells, arrowheads 802 can indicate animation paths, etc. The use of a graph to represent the detected strokes simplifies this processing. For example a simple smooth path 800 will generate a graph with two nodes of degree 1, and a single edge. Cross ticks will appear as edges of short length, connecting nodes of degree 1 with nodes of degree 3 or 4.

Drawn symbols: Some strokes may be interpreted as symbols, and used to qualify the meaning of other strokes. To simplify the determination of which strokes are symbols, the system may require that symbols be enclosed in a box.

As a fallback, a graphical user interface also allows the user to control stroke interpretation, although a goal of the system is to allow users to operate in physical space as much as possible. In one mode of the system, markup is not processed and used to modify the state of the system until the user explicitly triggers markup handling. That is done through a button in the interface, but could also be done by drawing a symbol such as a box containing an X. Because the system may sometimes misinterpret strokes, or the user may want to change the markup they have produced, the system supports an “Undo” operation.

Stroke Based Markup Processing

By utilizing a markup system which serves as a baseline for our embodiment of this invention, models are created and manipulated using a markup language consisting of markers. The markers can be thought of as ‘words’ in a spatial language, where a collection of markers act as ‘sentences’ that define models. The markers consist of QR codes and some fixed decorations that help users understand the metadata associated with the markers, that is, the meaning of the markers. Those decorations may simply be labels near the QR codes, such as “wall”, or arrows pointing to “activity hotspots” which are relevant points that lie away from the actual QR codes. In the baseline system the decorations for a type of marker are fixed and preprinted.

The inventive system follows the same framework of supporting a “markup language” to define models, but extends that framework to include freeform hand drawn strokes as part of the language. The markers may still be used, and are especially helpful for precisely determining geometry, but strokes may also be used to augment the markers, or in some cases to replace them.

Marker Augmentation

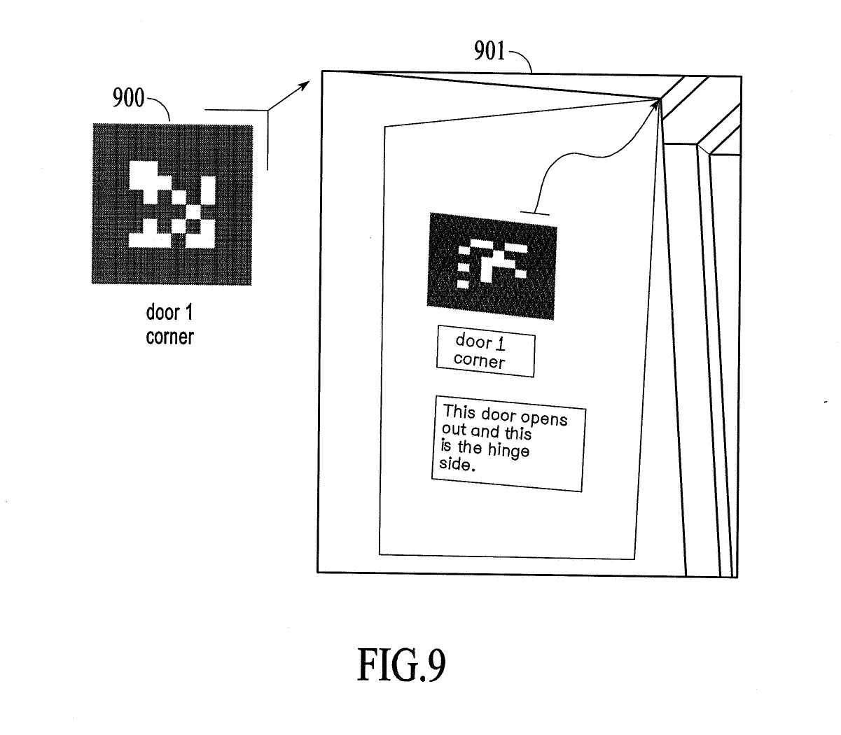

In the practice of using the baseline system, a common inconvenience was generating appropriate markers with the correct labels and associated metadata. For example in FIG. 9, in labeling the corner of a window, it is often convenient to have a ‘hotspot’ which is some distance from the center of the marker, and an arrow printed on the marker to indicate that hotspot 900. The techniques described here allow this metadata to be generated as needed simply by drawing it near the markers, or on the cards on which markers are printed. For example, the user may write a label, and draw an arrow to the hotspot 901, as shown in FIG. 9. As the marker is applied, a close-up image is captured, and processing on the strokes can be used to indicate both the type metadata, and the hotspot.

Strokes can also be used to augment a set of markers, and this augmentation may reduce the number of markers needed. This is especially useful for applications requiring the use of curves, such as defining the base shape of a curved section of wall. The baseline system could do this using a set of markers to define control points on a spline to approximate the shape of the curve. Using freeform strokes (or wires), a single marker augmented with the drawn stroke could be used.

Another use of drawn strokes as marker augmentation is simply to annotate the markers with comments describing issues that come up during markup.

Strokes as Replacements for Printed Markers

In addition to augmenting markers or sets of markers, strokes can be used as an alternative to markers. Many possible spatial languages could be defined for the interpretation of hand drawn strokes, but for concreteness a scheme here can be used based on the printed markers. In place of the square markers with QR codes, users can draw a symbol. The type of the box can be drawn underneath and lines indicating where a label and possible comment are drawn. Additional decorations to indicate one or more hotspots associated with the markers can be drawn near the box as in the previous example. FIG. 16 illustrates an example of a fully freeform markup 1000 for defining a cylinder. The hand drawn square and underline are relatively easy to detect. The label underneath could be processed by a handwriting recognition system. The comment does not need to be interpreted by the system, but can be kept as a bitmap for annotation purposes. Note that the cylinder is defined implicitly by giving 3 or more points on its base, rather than explicitly by drawing a curve for the base.

FIG. 17: illustrates example stroke and markup processing utilized by the system for providing interactive virtual content. In some of the application examples described previously, information from the Markup handling subsystem, such as the plane on which the strokes should be projected and the enclosing polygon, was used to generate the virtual models from the 2 dimensional stroke data. As described previously, the stroke processing can involve converting the strokes to greyscale and thresholding the images to black and white 1100. Stroke contours are identified 1101, and contour contraction is utilized 1102 to create a graph 1103. Graph reduction can then be applied 1104. The markup handling can involve finding the best frame for the processed polygon 1105 and projecting the points on to a plane 1106. The stroke type can be determined from the projected points 1107, and the virtual model can thereby be rendered from the determined stroke type 1108.

FIG. 12 illustrates an example functional diagram in which the system can be implemented. A camera 1200 points to a physical workspace with markup 1201 and forwards the live feed to the computer system 1202. The stroke extraction unit 1203 processes the live feed for freeform markup and strokes. The freeform markup and strokes processed from the live feed is then sent to a stroke processing unit 1203 which is interpreted for constructing a virtual model. The Virtual Modeling unit 1204 generates a virtual model based on the interpretation of the freeform markup. The virtual model is then forwarded for display 1205.

FIG. 13: illustrates an example flow chart of one of the embodiments of the invention. In one of the embodiments of the invention, the system receives live feed from a camera of a physical workspace 1300. The live feed is then processed for identifying physical freeform markup in the physical workspace 1301. Upon detecting the physical freeform markup, a virtual model is rendered based on the markup 1302, and then displayed on a display for the user 1303.

FIG. 14 illustrates an exemplary embodiment of a computer platform upon which the inventive system may be implemented.

FIG. 14 is a block diagram that illustrates an embodiment of a computer/server system 1400 upon which an embodiment of the inventive methodology may be implemented. The system 1400 includes a computer/server platform 1401, peripheral devices 1402 and network resources 1403.

The computer platform 1401 may include a data bus 1405 or other communication mechanism for communicating information across and among various parts of the computer platform 1401, and a processor 1405 coupled with bus 1401 for processing information and performing other computational and control tasks. Computer platform 1401 also includes a volatile storage 1406, such as a random access memory (RAM) or other dynamic storage device, coupled to bus 1405 for storing various information as well as instructions to be executed by processor 1405. The volatile storage 1406 also may be used for storing temporary variables or other intermediate information during execution of instructions by processor 1405. Computer platform 1401 may further include a read only memory (ROM or EPROM) 1407 or other static storage device coupled to bus 1405 for storing static information and instructions for processor 1405, such as basic input-output system (BIOS), as well as various system configuration parameters. A persistent storage device 1408, such as a magnetic disk, optical disk, or solid-state flash memory device is provided and coupled to bus 1401 for storing information and instructions.

Computer platform 1401 may be coupled via bus 1405 to a display 1409, such as a cathode ray tube (CRT), plasma display, or a liquid crystal display (LCD), for displaying information to a system administrator or user of the computer platform 1401. An input device 1410, including alphanumeric and other keys, is coupled to bus 1401 for communicating information and command selections to processor 1405. Another type of user input device is cursor control device 1411, such as a mouse, a trackball, or cursor direction keys for communicating direction information and command selections to processor 1405 and for controlling cursor movement on display 1409. This input device typically has two degrees of freedom in two axes, a first axis (e.g., x) and a second axis (e.g., y), that allows the device to specify positions in a plane.

An external storage device 1412 may be coupled to the computer platform 1401 via bus 1405 to provide an extra or removable storage capacity for the computer platform 1401. In an embodiment of the computer system 1400, the external removable storage device 1412 may be used to facilitate exchange of data with other computer systems.

The invention is related to the use of computer system 1400 for implementing the techniques described herein. In an embodiment, the inventive system may reside on a machine such as computer platform 1401. According to one embodiment of the invention, the techniques described herein are performed by computer system 1400 in response to processor 1405 executing one or more sequences of one or more instructions contained in the volatile memory 1406. Such instructions may be read into volatile memory 1406 from another computer-readable medium, such as persistent storage device 1408. Execution of the sequences of instructions contained in the volatile memory 1406 causes processor 1405 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1405 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as storage device 1408. Volatile media includes dynamic memory, such as volatile storage 1406.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 1405 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 1405. The bus 1405 carries the data to the volatile storage 1406, from which processor 1405 retrieves and executes the instructions. The instructions received by the volatile memory 1406 may optionally be stored on persistent storage device 1408 either before or after execution by processor 1405. The instructions may also be downloaded into the computer platform 1401 via Internet using a variety of network data communication protocols well known in the art.

The computer platform 1401 also includes a communication interface, such as network interface card 1413 coupled to the data bus 1405. Communication interface 1413 provides a two-way data communication coupling to a network link 1415 that is coupled to a local network 1415. For example, communication interface 1413 may be an integrated services digital network (ISDN) card or a modem to provide a data communication connection to a corresponding type of telephone line. As another example, communication interface 1413 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 1413 sends and receives electrical, electromagnetic or optical signals that carry digital data streams representing various types of information.

Network link 1413 typically provides data communication through one or more networks to other network resources. For example, network link 1415 may provide a connection through local network 1415 to a host computer 1416, or a network storage/server 1417. Additionally or alternatively, the network link 1413 may connect through gateway/firewall 1417 to the wide-area or global network 1418, such as an Internet. Thus, the computer platform 1401 can access network resources located anywhere on the Internet 1418, such as a remote network storage/server 1419. On the other hand, the computer platform 1401 may also be accessed by clients located anywhere on the local area network 1415 and/or the Internet 1418. The network clients 1420 and 1421 may themselves be implemented based on the computer platform similar to the platform 1401.

Local network 1415 and the Internet 1418 both use electrical, electromagnetic or optical signals that carry digital data streams. The signals through the various networks and the signals on network link 1415 and through communication interface 1413, which carry the digital data to and from computer platform 1401, are exemplary forms of carrier waves transporting the information.

Computer platform 1401 can send messages and receive data, including program code, through the variety of network(s) including Internet 1418 and LAN 1415, network link 1415 and communication interface 1413. In the Internet example, when the system 1401 acts as a network server, it might transmit a requested code or data for an application program running on client(s) 1420 and/or 1421 through Internet 1418, gateway/firewall 1417, local area network 1415 and communication interface 1413. Similarly, it may receive code from other network resources.

The received code may be executed by processor 1405 as it is received, and/or stored in persistent or volatile storage devices 1408 and 1406, respectively, or other non-volatile storage for later execution.

It should be noted that the present invention is not limited to any specific firewall system. The inventive policy-based content processing system may be used in any of the three firewall operating modes and specifically NAT, routed and transparent.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Perl, shell scripts, Java, etc.

Moreover, other implementations of the invention will be apparent to those skilled in the art from consideration of the specification and practice of the invention disclosed herein. Various aspects and/or components of the described embodiments may be used singly or in any combination in the system for creating interactive virtual content based on machine analysis of freeform physical markup. It is intended that the specification and examples be considered as exemplary only, with a true scope and spirit of the invention being indicated by the following claims.

What is claimed is:

1. A system for creating virtual models based on physical freeform markup, the system comprising:
a display;
a camera for receiving imagery from a physical workspace;
a processor processing the imagery from the camera and executing instructions comprising:
identifying and processing physical freeform markup on the physical workspace;
rendering a virtual model based on the physical freeform markup; and
displaying the virtual model on the display.

2. The system of claim 1, wherein the physical freeform markup further comprises freeform strokes created by a drawing implement.

3. The system of claim 1, wherein the physical freeform markup further comprises three dimensional objects.

4. The system of claim 1, wherein the instructions further comprise overlaying the virtual model on the imagery, and wherein the displaying comprises displaying the overlaid virtual model on the display.

5. The system of claim 1, wherein the instructions further comprise:
extracting a pathway from the physical freeform markup;
and
animating an object along the extracted pathway.

6. The system of claim 1, wherein the instructions further comprise:
extracting an activity hotspot from the physical freeform markup; and
sensing, from the imagery, interactions occurring within the activity hotspot.

7. The system of claim 1, wherein the processing the physical freeform markup comprises deriving a three dimensional path from the physical freeform markup.

8. The system of claim 1, wherein the instructions further comprise:
interpreting the physical freeform markup as a markup command.

9. The system of claim 5, wherein the instructions further comprise displaying the extracted pathway.

10. The system of claim 1, wherein the instructions further comprise:
analyzing the physical freeform markup for annotations, wherein if an annotation is found, storing the annotation into the system.

11. The system of claim 1, wherein walls or floors are constructed within the virtual model based on the markup.

12. A system for creating interactive virtual content based on physical freeform markup, the system comprising:
a display;
a camera for receiving imagery from a physical workspace;
a processor processing imagery from the camera and executing instructions comprising:
identifying and processing, from the imagery, physical freeform markup on the physical space; and
deriving a path from the physical freeform markup

13. The system of claim 12, wherein the instructions further comprises overlaying a three dimensional virtual model on the imagery, and displaying the overlaid virtual model on the display.

14. The system of claim 12, further comprising deriving a command from the physical freeform markup, wherein if the derived command is for indicating a pathway, the processing of the physical freeform markup further comprises:
extracting a pathway from the physical freeform markup;
and
animating an object along the extracted pathway.

15. The system of claim 12, further comprising deriving a command from the physical freeform markup, wherein if the derived command is for indicating an activity hotspot, the processing of the physical freeform markup further comprises:
extracting an activity hotspot from the physical freeform markup; and
sensing, from the imagery, interactions occurring within the activity hotspot.

16. The system of claim 12, further comprising deriving a command from the physical freeform markup, wherein if the derived command is for creating a virtual model, the processing of the physical freeform markup further comprises:
rendering a virtual model based on the physical freeform markup; and
displaying the virtual model on the display.

17. The system of claim 12, wherein the instructions further comprise:
analyzing the physical freeform markup for annotations, wherein if an annotation is found, storing the annotation into the system.

18. The system of claim 16, wherein the instructions further comprise: processing the imagery for markers; deriving a plane based on the processed markers; and determining 3D paths of planar strokes drawn on the derived planes.

19. The system of claim 12, further comprising deriving a command from the physical freeform markup, wherein if the derived command is for indicating a motion constraint, the processing of the physical freeform markup further comprises modeling limitations of movement for an object in a virtual model.

20. The system of claim 16, wherein walls or floors are constructed within the virtual model based on the markup.
